(19) United States
(12) Patent Application Publication
(10) Pub. No.: US 2026/0291083 A1
(43) Pub. Date: Sep. 24, 2026

(54) FLEXIBLE AND MODULAR ANTENNA DEVICE WITH A FLEXIBLE FILM SUBSTRATE CARRYING AT LEAST ONE RF-MODULE

(71) Applicant: Fraunhofer-Gesellschaft zur Foerderung der angewandten Forschung e.V., Munich (DE)

(72) Inventors: Marco DIETZ, Muenchen (DE); Christof LANDESBERGER, Muenchen (DE); Armin KLUMPP, Muenchen (DE)

(21) Appl. No.: 19/085,856

(22) Filed: Mar. 20, 2025

(51) Int. Cl. H01Q 21/00; H01Q 1/38

(52) U.S. Cl. CPC H01Q 21/0025; H01Q 1/2283; H01Q 1/38; H01Q 23/00

(57) ABSTRACT

A flexible and modular antenna device (100) is proposed, comprising a flexible film substrate (110) with electrically conductive wiring structures (120, . . . , 125), and a first RF-module (131) being arranged on the flexible film substrate (110), wherein the first RF-module (131) is coupled to the wiring structures (120, . . . , 125). The first RF-module (131) comprises a first interposer (141) with a first RF antenna structure (151), a first RF-chip (161), a plurality of contact pads (171, . . . , 175) for electrically contacting the first RF-chip (161), and vias (191, . . . , 194) extending through the first interposer (141) between the first interposer surface (141A) and an opposite second interposer surface (141B). The first RF-module (131) is mounted on the flexible film substrate (110), such that the contact pads (171, . . . , 175) on the first interposer (141) connect with the wiring structures (120, . . . , 125) on the flexible film substrate (110).

### TECHNICAL FIELD

Embodiments of the present disclosure relate to a flexible and modular antenna device. The antenna device comprises a flexible film substrate that can adapt the shape of an underlying surface thereby rendering the antenna device flexible. At least one RF-module (RF: Radio Frequency), or even two or more RF-modules, can be mounted on the flexible film substrate thereby rendering the antenna device modular.

### BACKGROUND

Antennas are used for transmitting and receiving electromagnetic radiation. They can be used for data transfer in mobile communication, for emitting and receiving electromagnetic waves in the context of radar technologies, but also as sensor elements in sensorics.

In a frequency range of 10 GHz to 140 GHz, electromagnetic waves may also be used for detecting objects as well as their movement and environment; these are typical RADAR applications. The higher the frequency, the more accurate the spatial resolution in RADAR detection. However, with increasing frequency, the “angle of view”, i.e., the spatial area from which reflected signals are received, becomes narrower and narrower. To still generate a complete image of the environment, antennas are rotated mechanically such that all angular areas are scanned.

A further option for spatial imaging are so-called phased-array antennas. Here, a matrix structure of several individual antenna elements, each of which acts as an individual antenna, are controlled by radio frequency signals that are phase-shifted with respect to each other, such that by superposition of all radiated individual waves, a constructive interference into one or several specific directions becomes possible all in all. This method is referred to as “beam steering.”

Nowadays, many antennas in the mobile radio range are equipped with such beam steering systems. Printed circuit boards are used as a production method, which comprise a plurality of defined conductive areas, e.g., copper structures. Thus, the antenna is formed by conductive structures on a rigid plate, wherein the antenna itself may be realized in so-called stripline technology. Such antennas are also referred to as stripline antennas.

Furthermore, antennas on flexible foil substrates are known, such as for RFID (radio frequency identification) applications. Here, a radio wave in the frequency range of 10 kHz to 10 GHz is transferred between a transmitter and a receiver, wherein a code is transferred and tested. In that way, for example, access authorization for rooms can be checked on doors in a contactless manner. For mass production of such RFID labels, antennas may be produced on PET foils. The foil substrate allows a cost-effective roll-to-roll production technology. The antennas can consist of etched or printed conductive trace structures or of fine wires laid in a matching coil shape.

Also antenna structures on glass substrates are known. Glass is used because of its low dielectric constant. Losses along a transmission line are therefore strongly reduced. Low power dissipation is an important criterion, as otherwise a lot of power has to be coupled in. Since always only part of the incoming electromagnetic wave is also radiated, a lot of energy is lost, which results in undesired heating of the antenna system as well as in a reduction of range.

Therefore, it is an objective of the herein described innovative concept to improve existing antenna structures to be capable of transmitting and/or receiving electromagnetic waves in a plurality of independent directions, but without the above mentioned drawbacks.

This goal is achieved by the herein disclosed flexible and modular antenna device with all the features of the independent claims. Further embodiments and advantageous aspects are suggested in the dependent claims.

The innovative flexible and modular multi-antenna device comprises a flexible film substrate with electrically conductive wiring structures, and at least a first RF-module (RF: Radio Frequency) being arranged on the flexible film substrate. The wiring structures may be provided as traces on the surface of the film substrate and/or they may be provided as one or more metal layers being integrated inside the film substrate.

The term “film” as used herein can be synonymously used with the term “foil”. It is defined in its usual meaning, e.g., a thin layer of material that can either be standalone or be arranged on an underlying surface. For example, a film can be attached to an underlying surface by common means, e.g., by adhering, laminating, depositing and the like. Due to its low thickness, a film is flexible and elastically deformable, i.e., it can be elastically deformed or bent (preferably by 360°) without getting plastically deformed or damaged. Due to its flexibility, the film can conform the geometrical shape of the underlying surface. In some instances, the film is a polymer film, such as polyimide, etc.

The first RF-module comprises a first interposer being suitable for high-frequency use, the first interposer having a first RF antenna structure arranged on a first interposer surface of the first interposer, and a first RF-chip arranged on the first interposer surface of the first interposer.

The term “interposer” as used herein is used in its common general technical meaning in the field of micro structuring technologies. An interposer is an electrical interface routing between one socket or connection to another. The purpose of an interposer is to spread a connection to a wider pitch or to reroute a connection to a different connection. An interposer comprises a substrate that can be arranged on or between one or more other substrates carrying functional components. Thus, an interposer can be regarded as some sort of adaptor. An interposer can be made of at least one of a semiconductor material, organic material or glass.

The first RF-chip is configured to provide RF-signals to, or receive RF-signals from, the first RF antenna structure and to translate the RF-signals into lower frequency baseband signals which are then transferred along the wiring structures of the flexible film substrate. For example, the first RF-module may communicate via said wiring structures with at least a second RF-module being mounted on the flexible film substrate.

The first RF-module further comprises a plurality of contact pads arranged on the first interposer surface for electrically contacting the first RF-chip, the contact pads being electrically coupled directly to the first RF antenna structure via short (preferably: shortest possible) conductor path structures.

The first RF-module further comprises a plurality of through-substrate-vias (in the following briefly referred to as “vias”). The vias are electrically conducting and extend vertically through the first interposer between the first interposer surface and an opposite second interposer surface.

The first RF-module is mounted with its second interposer surface on the flexible film substrate, such that the vias connect the contact pads on the first interposer surface with the wiring structures on the flexible film substrate.

Accordingly, the present innovative concept provides a modular antenna device comprising an RF-module having its own antenna and its own RF-chip. Thereby, the innovative antenna device becomes modular, i.e., it includes a separately replaceable module, namely the above mentioned first RF-module. As will be described in more detail below, the innovative antenna device may comprise at least a second RF-module, or even a plurality of additional RF-modules.

The innovative antenna device is provided on a flexible film substrate, thereby rendering the entire antenna structure flexible. The film substrate may, for instance, comprise the shape of a long strip. For example, a plurality of individual RF-modules may be mounted along said strip in a row one after the other. This may be comparable to a conventional LED-strip with a plurality of single LEDs being mounted in a row.

Accordingly, the innovative flexible and modular antenna device can, for instance, be mounted on a non-planar surface since the flexibility of the film substrate allows the entire antenna device to conform the shape of its underlying surface. Thus, the innovative antenna device may be mounted on almost any complex surface, for instance on car bumpers, drones, vacuum robots, airplanes, and many more. Accordingly, the innovative antenna device is suitable to be arranged on almost any three-dimensional body irrespective of its geometrical shape.

In the following, embodiments of the present disclosure are described in more detail with reference to the figures, in which

FIG. 1 shows a schematic side view of an innovative antenna device according to an embodiment,

FIG. 2 shows a schematic side view of an innovative antenna device according to a further embodiment,

FIG. 3 shows a schematic side view of an innovative antenna device having a multi-directional antenna radiation pattern according to a further embodiment,

FIG. 4 shows a schematic top view of an interposer that can be used in combination with an innovative antenna device according to an embodiment,

FIG. 5 shows a schematic bottom view of an interposer that can be used in combination with an innovative antenna device according to an embodiment,

FIG. 6 shows a schematic side sectional view of the interposer sectioned along line A-A in FIG. 4,

FIG. 7 shows a schematic side sectional view of the interposer sectioned along line B-B in FIG. 4,

FIG. 8 shows a schematic top view of a portion of a flexible base film substrate that can be used in combination with an innovative antenna device according to an embodiment, and

FIG. 9 shows a schematic side sectional view of a portion of a flexible base film substrate that can be used in combination with an innovative antenna device according to an embodiment,

### DESCRIPTION OF THE DRAWINGS

Equal or equivalent elements or elements with equal or equivalent functionality are denoted in the following description by equal or equivalent reference numerals.

Method steps which are depicted by means of a block diagram and which are described with reference to said block diagram may also be executed in an order different from the depicted and/or described order. Furthermore, method steps concerning a particular feature of a device may be replaceable with said feature of said device, and the other way around.

In the present disclosure, the innovative flexible and modular antenna device may be described with reference to a first RF-module by way of example. However, the innovative flexible and modular antenna device may comprise more than said first RF-module, namely a second RF-module, or even a plurality of additional RF-modules. Everything that will be discussed herein with respect to one particular exemplary RF-module also holds for each additional RF-module, even if not explicitly mentioned.

FIG. 1 shows a first exemplary embodiment of a flexible and modular antenna device 100 according to the present innovative concept. The antenna device 100 comprises a flexible film substrate 110.

The flexible film substrate 110 provides the possibility of freely scaling the size of the antenna device 100. For example, the flexible base film substrate 110 may be provided in the form of an elongated flexible strip having a length of 1 cm to 1 m or even more. Additionally or alternatively, film areas up to 1 m² or more can be provided as the flexible film substrate 110 for the complete antenna device 100.

The flexible film substrate 100 comprises electrically conductive wiring structures 120, . . . , 125. The wiring structures 120, . . . , 125 may be provided as surface striplines running on a top surface 111 or a bottom surface 112 of the film substrate 110. Additionally or alternatively, if the film substrate 110 may be configured as a multi-layer film stack, the electrically conducting wiring structures 120, . . . , 125 can be provided as integrated metal layers.

The antenna device 100 further comprises a first RF-module 131 (RF: Radio Frequency) being separately mountable on the flexible film substrate 110. The first RF-module 131 is electrically coupled to the wiring structures 120, . . . , 125 running inside, on or at the flexible film substrate 110, in a way as described above.

The first RF-module 131 comprises a first interposer 141 being suitable for high-frequency use, the first interposer 141 having a first RF antenna structure 151 arranged on a first interposer surface 141A of the first interposer 141.

The term “antenna structure” 151 as used herein applies equally to a radiating structure for transmitting RF-signals as well as to a wave-absorbing structure for receiving RF-signals. The latter can also be referred to as sensor for electromagnetic waves, here in particular in the radio-frequency range.

The first RF-module 131 comprises a first RF-chip 161 arranged on the first interposer surface 141A of the first interposer 141. The first RF-chip 161 is configured to provide RF-signals to, or to receive RF-signals from, the first RF antenna structure 151 and to translate the RF-signals into lower frequency baseband signals which can then be transferred along the conductive wiring structures 120, . . . , 125 of the underlying flexible film substrate 110.

The first RF-module 131 further comprises a plurality of contact pads 171, . . . , 174 arranged on the first interposer surface 141A of the first interposer 141 for electrically contacting the first RF-chip 161. The contact pads 171, . . . , 174 are electrically coupled directly to the first RF antenna structure 151 via short conductor path structures 180. For the sake of supreme signal quality, the conductor path structures 180 running between the contact pads 171, . . . , 174 and the first RF-chip 161 shall be as short as possible.

The first RF-module 131 further comprises one or more vias 191, . . . , 194 vertically extending through the first interposer 141 between the first interposer surface 141A and an opposite second interposer surface 141B.

The first RF-module 131 is mounted with its second interposer surface 141B facing the flexible film substrate 110, such that the one or more vias 191, . . . , 194 connect the contact pads 171, . . . , 174 on the first interposer surface 141A with the wiring structures 121, . . . , 125 on the flexible film substrate 110.

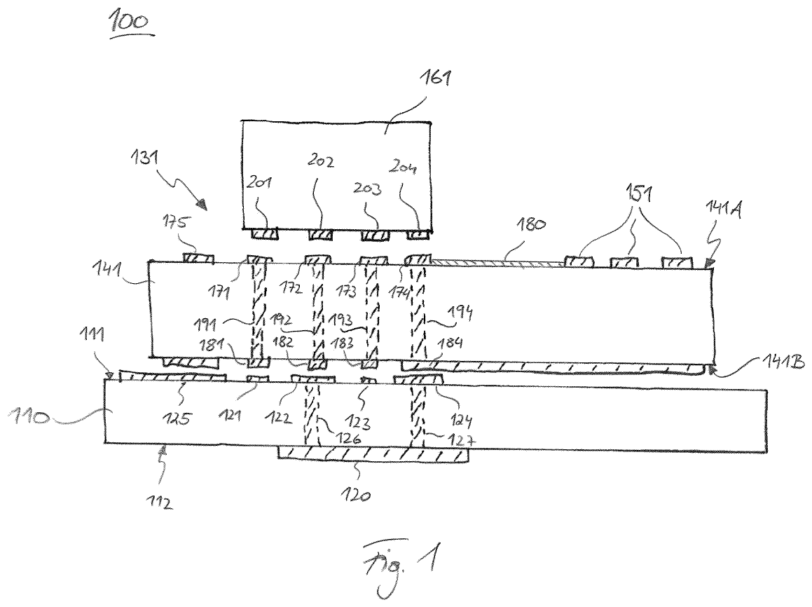

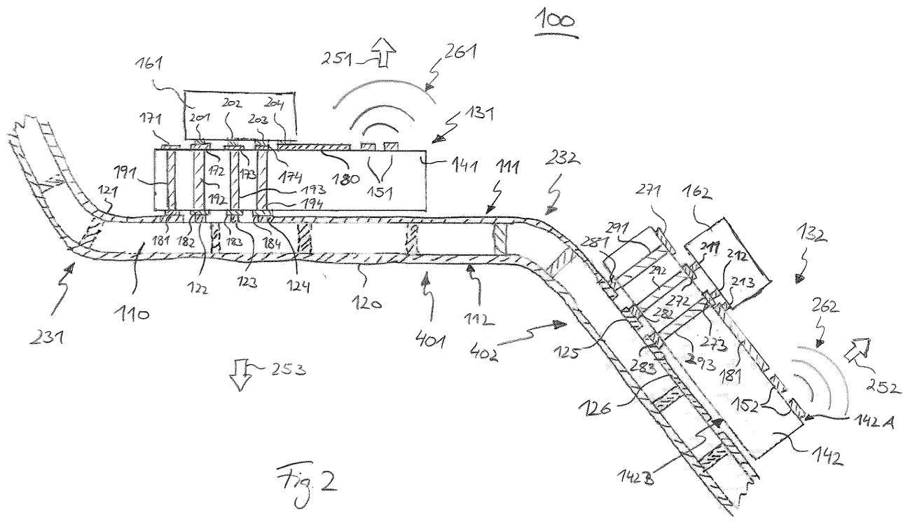

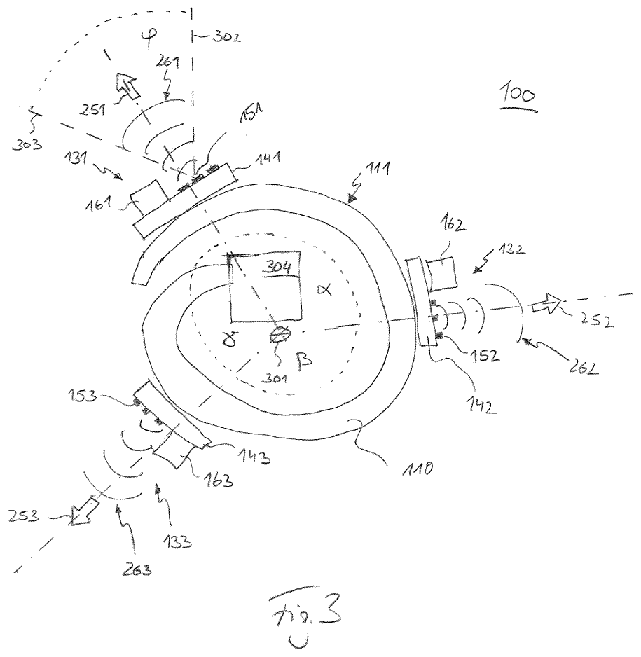

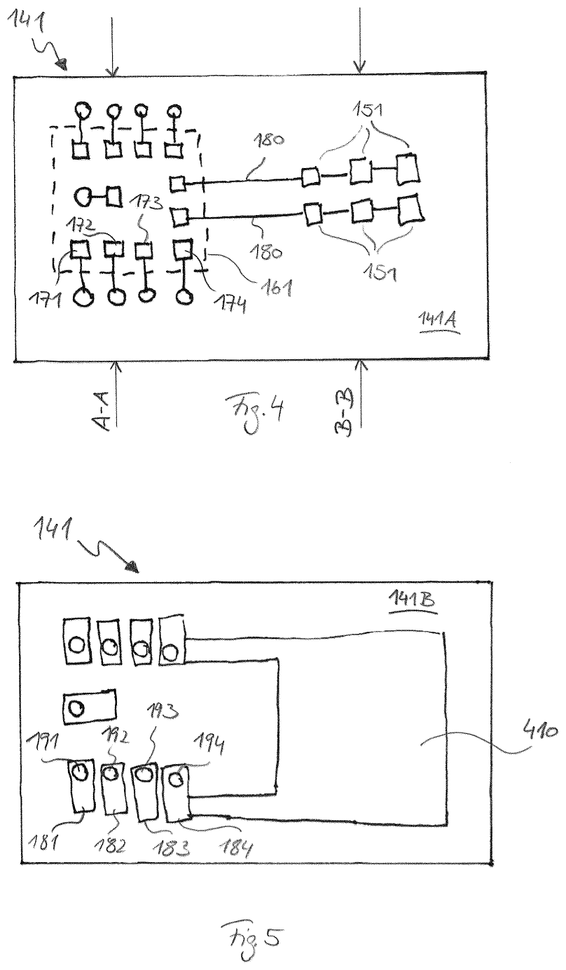

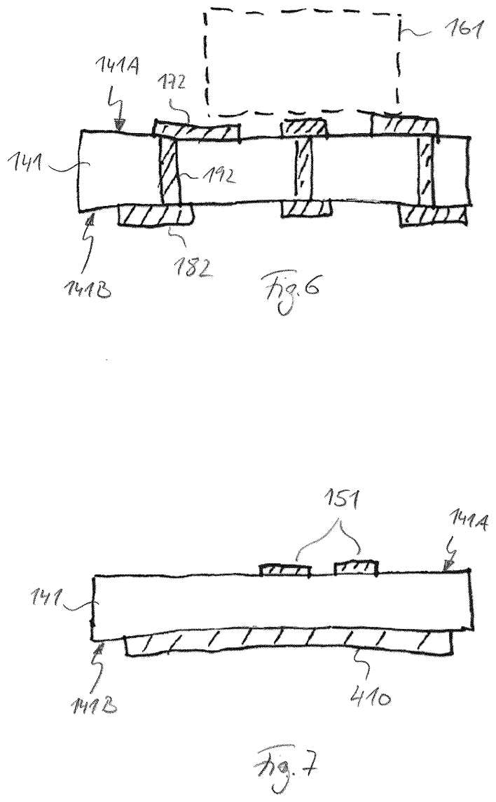

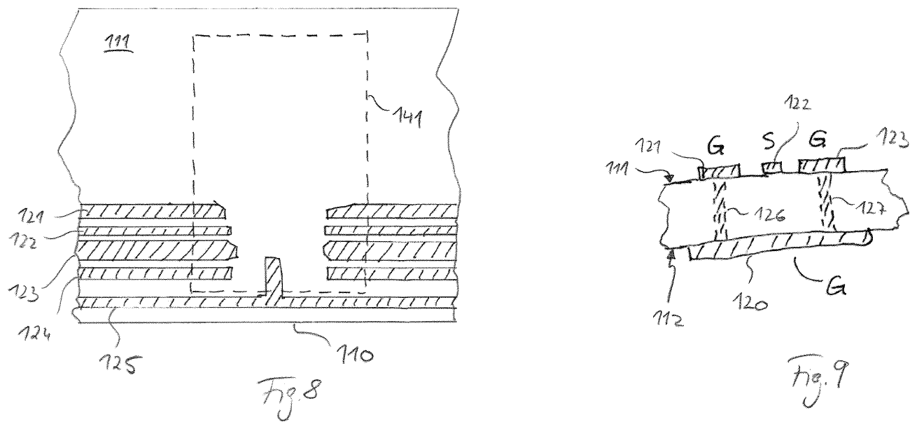

In FIG. 1, the interposer 141 is schematically drawn disconnected and, thus, spaced apart from the first RF-chip 161 and the flexible film substrate 110. In an assembled state, of course, the interposer 141 is connected with the first RF-chip 161 and the flexible film substrate 110 in a way as described above.

According to an exemplary embodiment, the first RF-chip 161 may be configured as a bare die being flip-chip mounted onto the contact pads 171, . . . , 174 being provided on the first interposer surface 141A of the first interposer 141. This configuration makes it easy to mount the first RF-chip 161 onto the first interposer 141 with only low space requirements.

For connecting the first RF-chip 161 to the underlying flexible film substrate 110 via the first interposer 141, a first contact pad 201 of the first RF-chip 161 may be coupled to a first contact pad 171 provided on the first interposer surface 141A. Said first contact pad 171 provided on the first interposer surface 141A may be connected to a first via 191. The first via 191 may terminate on an opposite first contact pad 181 provided on the opposite second interposer surface 141B. The opposite first contact pad 181 may be coupled with a first contact pad 121 being provided on a top substrate surface 111 of the flexible film substrate 110, said top substrate surface 111 facing the opposite second interposer surface 141B.

Accordingly, a signal path may be provided from a first contact pad 201 of the first RF-chip 161 to a first contact pad 171 provided on the first interposer surface 141A, then to a first via 191, then to an opposite first contact pad 181 provided on the opposite second interposer surface 141B, and then to a first contact pad 121 provided on the top substrate surface 111 of the flexible film substrate 110. The same holds for the other exemplary depicted galvanic connections, such as pads 122, . . . , 124; 172, . . . , 174; 182, . . . , 184; 202, . . . , 204 or vias 192, . . . , 194.

Thereby, the first RF-chip 161 can be coupled to the electrically conducting wiring structures 120, . . . , 124 provided on the top substrate surface 111 of the flexible film substrate 110 by means of the first interposer 141. Since this concept renders the entire antenna device 100 modular, the first interposer 141 carrying the first RF-chip 161 and the first RF antenna structure 151 may also be referred to herein as an RF-module, which in this particular case would correspond to the above discussed first RF-module 131.

After having discussed the general structure of the first RF-module 131, the first interposer 141 and the flexible film substrate 110, reference shall now be made to FIG. 2 showing a further embodiment of the innovative flexible and modular antenna device 100.

FIG. 2 shows an antenna device 100 comprising, in addition to the above discussed first RF-module 131, at least a second RF-module 132. The second RF-module 132 is similar, and may in some instances be identical, to the first RF-module 131.

The second RF-module 132 may be separately mountable on the flexible film substrate 110, next to the first RF-module 131 and spaced apart from the first RF-module 131. As exemplarily shown in FIG. 2, the first and second RF-modules 131, 132 may both be arranged on a same side of the flexible film substrate 110, e.g., on a first (top) side 111 of the film substrate 110. However, it may also be possible that the first and second RF-modules 131, 132 may be arranged on two opposite sides 111, 112 of the flexible film substrate 110.

The second RF-module 132 may be electrically coupled to the first RF-module 131 via the wiring structures 120, . . . , 125 of the flexible film substrate 110. As described above, the flexible (e.g., strip-like) base film substrate 110 may comprise conductive traces or wiring structures 120, . . . , 125 on its first (top) side 111 facing the RF-modules 131, 132. Additionally or alternatively, as exemplarily shown in FIG. 2, the flexible base film substrate 110 may comprise conductive traces or wiring structures, such as wiring structure 120, on an opposite second (bottom) side 112 facing away from the RF-modules 131, 132. The wiring structures 120, . . . , 125 may be made from structured metal layers and may be provided on one or both sides of the flexible film substrate 110, wherein the wiring structures 120, . . . , 125 can be deposited on top, or also embedded inside, the flexible film substrate 110.

The second RF-module 132 may comprise a second interposer 142 being similar or identical to the above discussed first interposer 141. The second interposer 142 is suitable for high-frequency use and has a second RF antenna structure 152 arranged on a first interposer surface 142A of the second interposer 142.

The second RF-module 132 may comprise a second RF-chip 162 being similar or identical to the above discussed first RF-chip 161. The second RF-chip 162 may be arranged on the first interposer surface 142A of the second interposer 142 and may be configured to provide RF-signals to, or receive RF-signals from, the second RF antenna structure 152. The second RF-chip 162 may translate the RF-signals into lower frequency baseband signals which can be transferred along the wiring structures 120, . . . , 125 of the flexible film substrate 110.

A plurality of contact pads 271, . . . , 273 may be arranged on the first interposer surface 142A of the second interposer 142 for electrically contacting the second RF-chip 162. The contact pads 271, . . . , 273 may be electrically coupled directly to the second RF antenna structure 152 via short (or shortest possible) conductor path structures 181.

Vias 291, . . . , 293, similar or identical to vias 191, . . . , 193, may extend through the second interposer 142 between the first interposer surface 142A and an opposite second interposer surface 142B of the second interposer 142.

The second RF-module 132 may be mounted with its second interposer surface 142B facing the flexible film substrate 110, such that the vias 291, . . . 293 connect the contact pads 271, . . . , 273 on the first interposer surface 142A with the wiring structures 120, . . . , 125 of the flexible film substrate 110.

As exemplarily depicted in FIG. 2, the flexible base film substrate 110 may be provided as a flexible/bendable foil or film that can comprise one or more curvatures 231, 232. Due to its flexibility, the flexible film substrate 110 is able to conform its shape to an underlying non-planar surface, wherein the shape of said surface can be invariable or variable. For example, a robot's surface may be variable, i.e., it may change its shape, in dependency of the robot's current movement.

While the antenna device 100 as depicted in FIG. 2 only illustrates one exemplary and non-limiting embodiment, it may also be possible that the antenna device 100 may comprise one or more additional RF-modules (not shown), e.g., a third RF-module, a fourth RF-module, and so on, in addition to the exemplarily depicted first and second RF-modules 131, 132. Each additional RF-module may comprise the same structure and the same features providing the same functionality as discussed above with reference to the first and/or second RF-modules 131, 132.

Since each RF-module 131, 132, . . . (each comprising an interposer 141, 142 carrying its own RF-chip 161, 162 and its own antenna structure 151, 152) can be separately arranged on the flexible film substrate 110, the flexible film substrate 110 may also be referred to as a base substrate or a flexible base film substrate. Accordingly, the innovative assembly concept is modular leading to the advantage that each of the individual RF-modules 131, 132, . . . can be individually prefabricated and can be electrically tested prior to system assembly.

A further advantage arising from providing a plurality of (e.g., two or more) RF-modules 131, 132 on one and the same base film substrate 110 is a so-called multi-directionality. For example, if a strip 110 carrying several assembled RF-modules 131, 132 (for example 6 to 12 units) is curved or bent, a multi-antenna device 100 may result that can transmit/receive and evaluate signals quasi simultaneously in/from a plurality of different directions.

For example, as schematically depicted in FIG. 2, the modular antenna device 100 may comprise a multi-directional antenna radiation pattern for transmitting and/or receiving signals quasi simultaneously in at least two different directions 251, 252.

For example, the first antenna structure 151 of the first RF-module 131 may have a first radiation pattern, which is schematically indicated by reference numeral 261. Said first radiation pattern 261 may comprise a predetermined directionality, i.e., it may comprise a first preferred radiation direction 251, which is different to an omnidirectional radiation pattern. However, the first antenna structure 151 may alternatively comprise an omnidirectional radiation pattern, wherein a backside RF-reflector 410 (which will be discussed in more detail later with reference to FIG. 5) may be provided for directing the radiation in a preferred direction 251.

The second antenna structure 152 of the second RF-module 132, in turn, may have a second radiation pattern, which is schematically indicated by reference numeral 262. Said second radiation pattern 262 may comprise a predetermined directionality, i.e., it may comprise a second preferred radiation direction 252, which is different to an omnidirectional radiation pattern. However, the second antenna structure 152 may alternatively have an omnidirectional radiation pattern, wherein an RF-reflector may be provided for directing the radiation in a preferred direction 252.

The first and second radiation patterns 261, 262 may be the same or different. For example, both antenna structures 151, 152 may have a directional radiation pattern for directing the radiation straight upwards and away from the interposer 141, 142, as exemplarily depicted in FIG. 2.

However, since the flexible film substrate 110 may be curved/bent and the first and second RF-modules 131, 132 may both be arranged along the first (top) surface 111 of the curved flexible film substrate 110, both RF-modules 131, 132 (i.e., their antenna structures 151, 152) may radiate in two different directions as indicated by arrows labelled with reference numerals 251 and 252. In particular, the above mentioned multi-directional radiation pattern of the antenna device 100 may be achieved by combining the signals received from the first RF-module 131 radiating in the first direction 251 and from the second RF-module 132 radiating in the different second direction 252.

In other words, the first RF-module 131 and the second RF-module 132 may be located at two different positions along the top surface 111 of the curved/bent flexible film substrate 110. Due to its curved/bent shape, the top surface 111 of the flexible film substrate 110, on which the RF-modules 131, 132 are arranged, points in different directions. Accordingly, also the first and second RF-modules 131, 132 are oriented towards two different directions, thereby radiating in two different directions 251, 252 for creating the above mentioned multi-directional radiation pattern of the innovative antenna device 100.

The flexibility of the base film substrate 110 allows to bend the base film substrate into a plurality of different geometrical shapes. Depending on said geometrical shape, also the antenna radiation pattern of the antenna device 100 may be shaped. For example, it becomes possible to provide a 360° degree antenna radiation pattern in a very easy and comfortable way.

FIG. 3 shows an exemplary embodiment of an antenna device 100 having a 360° degree antenna radiation pattern. In this example, the flexible base film substrate 110 comprises an open ring configuration, i.e., the film substrate 110 comprises at least one turn of at least 360°.

In this particular example, the film substrate 110 is bent into a circular or spiral shape, even though other geometrical shapes, such as any kind of angular shapes (e.g., rectangular, hexagonal, etc.) may be possible, as long as the film substrate 110 makes at least one full turn. Accordingly, the film substrate 110 may be comparable to a wire of a coil, wherein the wire makes at least one full turn, irrespective of the geometrical shape of the coil itself, i.e., the coil itself can be circular, angular, or the like.

In the example shown in FIG. 3, three RF-modules 131, 132, 133 are arranged along the first (top) surface 111 of the flexible base film substrate 110. Since the base film substrate 110 is wound in a spiral shape, the first surface 111 of the base film substrate 110 may also be referred to as an outer circumferential surface.

Each of the three RF-modules 131, 132, 133 comprise an interposer 141, 142, 143 carrying its own RF-chip 161, 162, 162 and its own antenna structure 151, 152, 153. Furthermore, each RF-module 131, 132, 133 has a predetermined radiation pattern 261, 262, 263 defining a preferred transmission/reception direction 251, 252, 253.

In this exemplary embodiment, the RF-modules 131, 132, 133 are arranged on the outer circumference 111 of the base film substrate 110 such that their preferred transmission/reception directions 251, 252, 253 are oriented in different directions. In this case, each of the RF-modules 131, 132, 133 is arranged such that its preferred transmission/reception direction 251, 252, 253 comprises a predetermined angular displacement to its directly adjacent RF-module, when viewed from a side elevational view as depicted in FIG. 3.

For example, if three RF-modules 131, 132, 133 are provided, as exemplarily depicted in FIG. 3, they may be arranged such that their preferred transmission/reception directions 251, 252, 253 comprise an angular displacement of 120° between each directly adjacent RF-module.

For instance, the first and second RF-modules 131, 132 are arranged such that their preferred transmission/reception directions 251, 252 comprise an angular displacement α of α=120° between each other.

The second and third RF-modules 132, 133 are arranged such that their preferred transmission/reception directions 252, 253 comprise an angular displacement β of β=120° between each other.

And the third and first RF-modules 133, 131 are arranged such that their preferred transmission/reception directions 253, 251 comprise an angular displacement γ of γ=120° between each other.

Of course, the aforementioned angular displacements α, β, γ do all refer to a common junction point, e.g., a center 301 of the spirally shaped antenna device 100.

It may also be possible that more than the exemplarily depicted three RF-modules 131, 132, 133 may be arranged on the outer circumferential surface 111 of the base film substrate 110. For example, six RF-modules may be arranged such that their preferred transmission/reception directions comprise an angular displacement of 60° between each adjacent RF-module.

Stated in more general terms, depending on the number of RF-modules being provided on the flexible base film substrate 110, each of the available RF-modules may be arranged such that its preferred transmission/reception direction comprises a predetermined angular displacement to its directly adjacent RF-module, wherein said angular displacement may be calculated by 360° divided by the number of available RF-modules. For instance, if four RF-modules were provided, they may be arranged with an angular displacement of 360°/4=90°.

The above mentioned preferred radiation directions 251, 252, 253 can be determined by considering the respective main lobes of the respective antenna structures 151, 152, 153. The main lobe is the direction in which an antenna structure 151, 152, 153 radiates most of its power. However, each RF-module 131, 132, 133, . . . may also comprise a scattering angle being defined by what is called side lobes. As exemplarily depicted with reference to the first RF-module 131, its antenna structure 151 may not only have the above discussed preferred radiation direction 251 defined by its main lobe, but it may also comprise side lobes defining a scattering angle φ.

With respect to the exemplary embodiment as discussed above with reference to FIG. 3, it may be advantageous if each RF-module 131, 132, 133, . . . may comprise a scattering angle φ that is at least as large as its angular displacement α, β, γ to its directly adjacent RF-module. For example, if three RF-modules 131, 132, 133 are provided, as shown in FIG. 3, the angular displacement α, β, γ is 120° each, as discussed above. In this case, it is preferred that each RF-module 131, 132, 133, . . . has a scattering angle of φ≥120°. In this case, each RF-module 131, 132, 133 may radiate inside a sector of 120° (indicated by dashed lines 302, 303), which is defined by its scattering angle of φ≥120°. Accordingly, when combining the three 120°-sectors of all three RF-modules 131, 132, 133, a total radiation characteristic of 360° may result. In other words, the 120° sectors may be stitched together, comparable to a 360° camera comprising multiple lenses.

In this regard, it may be a preferred embodiment that the RF-modules 131, 132, 133, . . . may comprise a scattering angle of φ being larger than the angular displacements α, β, γ, i.e., φ>α, φ>β, and φ>γ. Accordingly, in the example shown in FIG. 3, φ may be larger than 120°, i.e., φ>120°. In this case, the scattering angles φ of all RF-modules 131, 132, 133 may overlap or intersect each other to a certain extent providing for a more accurate 360° view.

As mentioned before, the sectors of each RF-module 131, 132, 133, . . . may be stitched together comparable to a 360° camera comprising multiple lenses. This may be particularly advantageous if the RF-modules 131, 132, 133 are configured to operate in a RADAR transmission range. In this case, it may be possible to gather a 360° RADAR image by combining the individual partial or sectional views of the single RF-modules 131, 132, 133. For example, as shown in FIG. 3, each RF-module 131, 132, 133 may provide a RADAR image showing a partial view of 120°, each in a different direction. These three 120° partial RADAR images may then be combined to a 360° total RADAR image.

For this purpose, a central control unit 304 may be provided. The control unit 304 may comprise a microcontroller. The control unit 304 may be coupled to the first RF-module 131, to the second RF-module 132 and to the third RF-module 133 via the electrically conducting wiring structures 120, . . . , 125 of the flexible film substrate 110, wherein the control unit 304 may be configured to generate an RF-output signal of the antenna device 100 based on a combination of a first RF-signal received from the first RF-module 131, a second RF-signal received from the second RF-module 132 and a third RF-signal received from the third RF-module 133.

Accordingly, the signals/data of all available RF-modules 131, 132, 133, . . . may be provided to the central evaluation or control unit 304 (e.g., comprising a micro-controller) via a bus system (being formed by the conductive traces or wiring structures 120, . . . , 125 comprised by the base film substrate 110). This control unit 304 may then provide a complete 360-degree image. If the RF-modules 131, 132, 133 may operate in the RADAR frequency range, a complete 360° RADAR image may be provided.

Briefly returning to FIG. 2, though not explicitly shown, a full 360° degree view may also be possible if the flexible film substrate 110 is kinked, similar to folding a sheet of paper, such that a first inner circumference portion 401 (e.g., opposite the first RF-module 131) may face a second inner circumference portion 402 (e.g., opposite the second RF-module 132). In this case, the first and second RF-modules 131, 132 may be positioned directly opposite to each other, wherein both RF-modules 131, 132 (i.e., their antenna structures 151, 152) may radiate in exactly two opposite directions, e.g., to the left side and to the right side. This is schematically indicated in FIG. 2 by the two arrows labelled with reference numerals 251 and 253.

If both RF-modules 131, 132 (i.e., their antenna structures 151, 152) were to comprise a radiation pattern 261, 262 having a scattering angle φ of at least φ≥180°, then the first RF-module 131 may cover a first 180° area to a first side (e.g., the entire left side), while the second RF-module 132 may cover a second 180° area to an opposite second side (e.g., the entire right side). Thereby, the antenna device 100 may comprise a 360° antenna radiation pattern.

In other words, the first RF-module 131 and the second RF-module 132 may be located at two opposite sides at the outer circumference 111 of the curved flexible film substrate 110, so as to be oriented towards two opposite directions and thereby radiating in two opposite directions 251, 253 for creating a 360° degree antenna radiation pattern of the antenna device 100.

Accordingly, if a strip-like film substrate 110 carrying several assembled RF-modules 131, 132 (for example 6 to 12 units) comprises a ring shape or a kinked shape, a flexible and modular antenna device 100 may result that can transmit/receive in a plurality of directions, or preferably in all directions covering a 360° all-around view.

As mentioned above, the flexible film substrate 110 may be configured to conform its shape to an underlying non-planar surface. For more complex geometrical structures, a plurality of flexible film substrates 110, (e.g., in the form of elongated foil strips) may be provided, wherein each film substrate 110 may carry one or more RF-modules 131, 132, as discussed above. Said plurality of flexible film substrates 110 may be arranged three-dimensionally, for example such that several strips form a spherical, e.g., ball-like, surface. In this case, not only viewing in a 360-degree plane is possible, but actually each angular area in the three-dimensional space may be detected.

As further mentioned before, due to the flexibility of the film substrate 110 (allowing a 360-degree bending), the antenna device 100 can radiate, i.e. transmit and/or or receive, in opposite directions. According to the prior art, this is not possible by using rigid printed circuit boards, even for the case of phased-array antennas.

In the prior art, instead, optimization of the directional dependency of radiating or receiving electro-magnetic waves will be solved by phased-array antennas. According to the invention, however, an opposite idea is suggested, namely combining individual RF-modules 131, 132 being oriented in at least two different directions. Optimization of the directional dependency may then be accomplished by simply bending the flexible base film substrate 110.

If a skilled person wants to build an antenna that can “look” in opposite directions, according to the prior art, he or she would arrange individual RF-modules (with RF chip and antenna) being mounted on small printed circuit boards (PCBs) with their rear sides facing each other, and would then connect the boards using common coaxial cables. However, with increasing number of such conventional PCB antenna arrangements, a lot of coaxial cables would be needed, i.e., a lot of material, a lot of bulk and a lot of volume. The present invention instead suggests a film-connecting technology between all RF-modules 131, 132, which significantly reduces the consumption of material, weight, and volume.

Different to the prior art, the structure of the inventive antenna device 100 comprising the flexible base film substrate 110 offers the option of positioning antennas (or generally sensors for electromagnetic waves) on a variable surface. As a non-limiting example, a variable surface may be a surface having an outer contour that can be varied/changed in a defined manner during operation. This can be advantageous for a controllable adjustment of the main radiation direction of the inventive antenna device 100.

Even in this regard the innovative concept is contrary to the prior art, according to which a skilled person would rather use or develop a so-called phased-array antenna where the “angle of view” is achieved by a phase shift between different antenna elements which are all arranged in a planar manner (on a rigid printed circuit board).

As mentioned above, the innovative flexible and modular antenna structure 100 may comprise at least one RF-module 131, and preferably two or more RF-modules 131, 132. The RF-modules 131, 132, each of which comprise its own antenna structure 151, 152 and its own semiconductor device/RF-chip 161, 162, may comprise a considerably smaller footprint compared to the flexible base film substrate 110, allowing a plurality of such RF-modules 131, 132 being mounted one after the other in a row on a, e.g., strip-like, flexible base film substrate 110. Each RF-module 131, 132 comprises an interposer 141, 142 on which its own RF-chip 161, 162 and its own antenna structure 151, 152 are mounted, as described above. Accordingly, the combination of an individual interposer 141, 142 with an individual antenna structure 151, 152 and an individual RF-chip 161, 162 is referred to herein as an RF-module 131, 132 rendering the antenna device 100 modular.

As can best be seen in FIGS. 1 and 2, with exemplary reference to the first RF-module 131, the geometry of the first antenna structure 151 and the contact pads 201, 203 for mounting the first RF-chip 161 is configured such that the connecting length between the first antenna structure 151 and the first RF-chip 161 is as short as possible; i.e., the first RF-chip 161 is mounted directly on a short conductor path structure 180 (conductive trace) leading to the first antenna structure 151. This provides for a shortest, and thus fastest, possible signal transmission and processing.

The RF-chip 161 itself may be configured to provide and read-out radio-frequency signals (RF-signals) that may be carried in a high frequency (HF) range, e.g., between 1 GHz and 350 GHz. Accordingly, the RF-signals may also be referred to as HF-signals. They are processed by means of passive and active RF-circuits.

An RF-chip 161 that is specifically suitable for processing radio-frequency signals up to 100 GHz in D band (110 GHz to 170 GHz) or in J band (220 GHz to 325 GHz) may, for instance, comprise or be made from semiconductor materials like SiGe, FDSOI, CMOS, GaAs, GaN, etc. The RF-chip 161 may be mounted in flip-chip configuration on the top of the interposer 141. Here, the IC is referred to as the RF-chip 161.

The RF-chip 161 may be configured to process the RF-signals, i.e., the RF-chip 161 may determine parameters like runtime or phase differences as well as amplitude changes of radiated and reflected or transmitted RF-waves and may translate the same into lower-frequency base-band signals which are then continuously transferred, e.g., via the electrical vias 191, . . . , 194 in the interposer 141, to the wiring structures 120, . . . , 125 of the flexible base film substrate 110. Accordingly, said transferred RF-signals do no longer have to be transmitted in the highest frequency range (100 GHz to 300 GHz), but merely in a lower GHz frequency range or in a higher MHz range, respectively. These lower-frequency base-band signals can be more easily transmitted, i.e., with low loss, through the conductive wiring structures 120, . . . , 125 along the flexible base film substrate 110, but also across longer distances, for example up to 1 m length. Thus, the wiring structures 120, . . . , 125 may also be referred to as conductive traces. The flexible base film substrate 110 may comprise or consist of polymer materials, for example polyimide, etc.

Generally, it is preferred that each functional part of the innovative antenna device 100 comprises a material that is optimally suited for its respective function. These are, for example, a semiconductor material like silicon-germanium (SiGe) for the RF-chips 161, 162, copper or gold conductive traces on glass for the interposers 141, 142 and polymers like polyimide for the flexible film substrate 110.

The interposers 141, 142 may comprise or be made from a material that is suitable as a substrate material for radio-frequency signals, and in particular for high-frequency signals, with the requirement of a particularly low-loss transmission. Suitable materials may include, for example, glass, quartz, or a ceramic composite material suitable for RF applications.

Furthermore, the flexibility/bendability of the innovative antenna device 100 can be obtained, or at least improved, by using flexible interposer materials. Also in this regard, thin, flexible glass may be the material of choice for the interposers 141, 142.

A person skilled in the art would not use glass since it is known that thin glass has a very high risk of breaking and may therefore break during the production processes, for example in the semiconductor fab, and hence would block the entire production process significantly. The authors of the present disclosure, however, discovered that secure handling of thin glass substrates in a production process may be possible with high yield if suitable carrier or stabilization techniques are introduced. The final system may be protected from breaking if the thin glass interposer 141, 142 may be laminated on the underlying flexible film substrate 110. Such a glass-film composite structure provides very good stability.

As alternative to thin glass, a skilled person may suggest using Teflon®-like materials since they do also have a very low dielectric constant. However, Teflon® has bad adhesive characteristics with regard to conductive trace structures deposited thereon, and therefore Teflon® offers no practicable solution.

The interposers 141, 142 and the RF-chips 161, 162 themselves may both comprise a rigid structure. The term rigid as used herein is meant to be used in its conventional definition, which means that a rigid material can undergo a plastic deformation, after which it does not return to its initial state or even suffers damage. The plastic deformation may depend, inter alia, on material characteristics and material thickness. At least within the present disclosure, an interposer 141, 142 may be considered rigid if it cannot be bent by the same amount as the flexible film substrate 110. Or stated the other way around, an interposer 141, 142 may be considered rigid if it gets plastically deformed or damaged upon being bent by the same amount as the flexible film substrate 110.

Alternatively, the interposers 141, 142 may be flexible/bendable, such as the flexible base film substrate 110. The terms flexible or bendable as used herein are meant to be used in their conventional definition, which means that a flexible or bendable material can be bent by a certain amount without breaking or getting otherwise damaged. In other words, a flexible or bendable material that undergoes an elastic deformation will return to its initial state without damage. At least within the present disclosure, an interposer 141, 142 may be considered flexible/bendable if it can be bent by the same amount as the flexible film substrate 110 without getting damaged.

An elastic deformation may depend, inter alia, on material characteristics and material thicknesses. For example, if glass is used for the interposers 141, 142, the interposers 141, 142 may be considered rigid if the glass material has a thickness of more than 300 μm. If glass having a thickness of 100 μm or less, preferably below 40 μm, is selected instead, the interposers 141, 142 may also become bendable, at least to such an extent that the RF-modules 131, 132 can adapt to a curved surface. This applies even if the RF-chips 161, 162 mounted on the RF-modules 131, 132 may be rigid, i.e., not elastically deformable. This is due to the fact that the RF-chips 161, 162 may have a very small footprint, e.g., less than 2 mm edge length, and the RF-chips 161, 162 may be provided as unhoused bare dies.

Thus, while the interposers 141, 142 themselves may be flexible, the RF-modules 131, 132 may remain rigid only at the location of the RF-chips 161, 162, i.e., across a very small length of 2 mm or less. This may lead to an only slight and locally limited deviation from a continuous curvature. Accordingly, the entire RF-modules 131, 132 can be considered flexible.

A further option for realizing elastically deformable and RF-suitable interposers 141, 142 may be the usage of composite materials in foil form. This would be an alternative to very thin bendable glass as the material selected for the interposers 141, 142. The above arguments, regarding flexibility when using small-footprint but rigid RF-chips 161, 162, do however also apply here.

As mentioned above, the antenna structures 151, 152 being realized on the interposers 141, 142 may have very high requirements regarding the stability of their directional characteristics. If glass is used for the interposers 141, 142, this can, for example, be accomplished by providing a glass wafer with precisely defined and ultra-fine conductive areas (forming the antenna structures 151, 152) during common semiconductor production. Additionally, the radio-frequency suitable interposers 141, 142 may comprise electrical contact pads 171, . . . , 175; 271, . . . , 275 on their top sides (first interposer surfaces 141A, 142A) and electrical contact pads 181, . . . , 185; 281, . . . , 285 on their bottom sides (second interposer surfaces 141B, 142B) as well as conductive vias 191, . . . , 194; 291, . . . , 293 extending through the interposers 141, 142 for connecting the contact pads on both sides.

Regarding the above mentioned proper material selection and regarding suitable manufacturing processes, the RF-modules 131, 132 can be realized with standard semiconductor technologies. For example, conductive trace structures forming the antenna structures 151, 152 can be realized on interposer wafers, e.g., made from glass or glass panels, via lithographical structuring of copper or gold. Thus, a plurality of RF-modules 131, 132 can be manufactured in parallel, i.e., in a very cost-efficient way with multiple benefits. The RF-chip assembly on the interposers 141, 142 (e.g., a glass wafer) can also take place on wafer level, i.e., using a well-known automated standard method.

The flexible base film substrate 110 may comprise or be made from a polymer, such as polyimide or the like. Polyimide is available in high quality. Thus, the surface roughness of polyimide is very low, in particular significantly lower than for the standard printed circuit board material FR4. Additionally, compared to FR4, the dielectric constant of polyimide is lower. The high quality of polymer films allows high-precision structuring of all conductive trace structures 120, . . . , 125. This is advantageous for low-loss transmission of RF signals and is also decisive for the correct simulation and optimized design of the entire RF system.

Using polymer films as a carrier of conductive traces 120, . . . , 125 for transmitting electrical radio-frequency signals for antenna structures 151, 152 was so far excluded by a person skilled in the art, since the electrical losses (attenuation) are too high for most polymers. Such a system would have to be operated with high power in order to be able to transmit sufficient signal strength. However, high power means high heat loss as well as high energy loss and hence bad efficiency.

According to the invention, however, this problem is solved in that a specific substrate material, such as glass, may be used for the interposers 141, 142 carrying the antenna structures 151, 152, and the RF signals of 10 GHz to 350 GHz are processed directly in the RF-chips 161, 162 at the location of the antenna structures 151, 152. The signal transmission to or away from the RF-chips 161, 162 takes place via the wiring structures 120, . . . , 125 on the flexible polymer film substrate 110 at considerably lower frequencies, as is common for micro-controller ICs.

As mentioned above, the electrical functionality of the RF-chips 161, 162 is the provision as well as the read-out of RF-signals. The RF-signals are processed by means of passive and active circuits that are ideally suitable for that. The RF-chips 161, 162 may process these signals, i.e., the RF-chips 161, 162 may determine, for example, runtime or phase differences as well as amplitude changes of radiated and reflected or transmitted waves and may translate the same into lower frequency base-band signals which are then continuously transferred, via the electrical vias 191, . . . , 194; 291, . . . , 293 formed in the interposers 141, 142, to the wiring structures 120, . . . , 125 in the flexible base film substrate 110.

The transferred lower-frequency signals do no longer have to be transmitted in the highest frequency range (100 GHz to 300 GHz), but merely in a higher MHz or lower GHz frequency range. These lower frequencies can be easily transmitted, i.e., with low loss, via copper conductive traces 121, . . . , 125 on polymer foils (for example polyimide, etc.), but also across longer distances, for example up to 1 m length.

In particular, in the millimeter-wave and sub-THz range, the dimensions of the layer structure of the flexible polymer foil technology and the wavelength of the used frequencies are in an optimum ratio. However, the directional characteristic of the antenna structures 151, 152 and, hence, also of the entire antenna device 100 can be significantly improved by an optional additional reflector.

One non-limiting example of a reflector shall be discussed with reference to FIGS. 4 to 7. FIG. 4 shows a top view onto the first interposer 141, i.e., showing the first (front side) interposer surface 141A. Like elements with like functionality, as discussed above, are referenced with like reference numerals. For example, the contact pads 171, . . . , 174 are depicted, as well as the first antenna structure 151 and the shortest possible conductor path structures 180 between the first antenna structure 151 and the contact pads 171, . . . , 174. The dashed lines symbolize the position of the first RF-chip 161.

FIG. 5 shows a bottom view onto the first interposer 141, i.e., showing the second (backside) interposer surface 141B. Like elements with like functionality, as discussed above, are referenced with like reference numerals. For example, the contact pads 181, . . . , 184 are depicted, as well as the vias 191, . . . , 194. Additionally, an optional backside RF-reflector 410 is depicted here.

In this non-limiting example, the backside RF-reflector 410 can be provided as a metallization layer being arranged on the second (backside) interposer surface 141B of the first interposer 141 opposite the first interposer surface 141A. Even though not explicitly shown here, the backside RF-reflector 410 may additionally or alternatively be integrated inside the interposer 141, for example by being provided as a metallization layer being integrated inside the first interposer 141.

In either way, when viewed from the top or bottom, as depicted in FIGS. 4 and 5, the RF-reflector 410 faces the first RF antenna structure 151. Thus, the RF-reflector 410 is able to reflect RF-waves 261 (FIG. 2) emitted from the first RF antenna structure 151 back in the opposite direction (e.g., in direction 251 as shown in FIG. 2).

FIG. 6 shows a cross-sectional view of the first interposer 141 along line A-A in FIG. 3, and FIG. 7 shows a cross-sectional view of the first interposer 141 along line B-B in FIG. 4. Like elements with like functionality, as discussed above, are referenced with like reference numerals.

In particular with reference to FIG. 7, it can be seen that the optional backside RF-reflector 410 may be arranged on the second (backside) interposer surface 141B so as to directly face and surround the first antenna structure 151 on the first (front side) interposer surface 141A.

The RF-reflector 410 contributes to concentrating the radiated energy in one direction. In a possible embodiment, the RF-reflector 410 may be flexible, and hence, the antenna device 100 can be configured in a flexible, bendable manner, even if a RF-reflector 410 is present.

Of course, the second interposer 142, as well as any other interposers of potential further RF-modules, may comprise an RF-reflector 410 as discussed herein. With the aid of an RF-reflector 410, the directional characteristic of the individual RF-modules 131, 132, can be significantly improved, which allows a precise sectioning, in particular in case of a 360° degree view of a multi-antenna device 100 as discussed above.

Additionally or alternatively, flexible/bendable reflector elements 410 may not only be provided on the interposers 141, 142, but may optionally also be provided on a backside 112 of the flexible base film substrate 110. The directional characteristic and efficiency of the entire antenna device 100 may be significantly increased by additional flexible reflector elements 410 being disposed, in or on the back side of the flexible base film substrate 110.

As mentioned before, with exemplary reference to the first interposer 141, the RF-reflector 410 may be provided in the form of a backside metallization being arranged on the second interposer surface 141B of the first interposer 141, as shown in FIGS. 5 and 7, or the RF-reflector 410 may be provided as a metallization layer being integrated inside the first interposer 141 or inside the flexible film substrate 110, respectively. However, as mentioned before, the same holds for all other interposers 142, 143, . . . including their respective first and second interposer surfaces.

In this regard, metallic structures may be exposed in the multi-layer foil structure 110 on a layer that is furthest from a layer where the antenna structures 151, 152 are realized. Additionally, the substrate 110 as well as any other metallic layers between these two layers may be removed, whereby the rear losses are significantly reduced. By varying the layer distances during processing, the optimum distance can be obtained in dependence of the wavelength between reflector 410 and antenna structure 151, 152.

This approach of exposing a metal structure from adjacent and superposed structures can also be used to form a cavity in the interposers 141, 142, wherein the RF-chips 131, 132 can be integrated inside said cavities. In some embodiments, the RF-chips 161, 162 can be integrated inside the cavities such that their upper edges terminate flush with the metallic layer carrying the antenna structures 151, 152. In this case, however, an additional metallization layer (e.g., a redistribution layer) may be arranged at the first (front side) interposer surface 141A for providing an electric connection between a top surface of the RF-chip 161 (since the RF-chip 161 itself is buried flush inside the cavity) and the antenna structure 151.

By additional casting, encapsulation of the RF-chips 161, 162 can be obtained in that way in order to protect the same from environmental influences. Additionally, a very short and low-loss HF-suitable connection between the RF-chips 161, 162 and the antenna structures 151, 152 in the millimeter-wave and sub-THz area becomes possible.

FIGS. 8 and 9 show further details of the flexible base film substrate 110 according to some embodiments. FIG. 8 shows a top view onto the top surface 111 of the base film substrate 110 that faces the interposers 141, 142 when assembled. The dashed lines symbolize the outline of one of the interposers 141, 142 in an assembled state.

As can be seen, the interposer 141 is positioned so as to contact the electrically conducting wiring structures 121, . . . , 125 of the flexible film substrate 110. The electrically conducting wiring structures 121, . . . , 125 are arranged in a so-called Ground-Signal-Ground (GSG) configuration, which is also referred to as a grounded coplanar waveguide configuration.

In this case, a signal line 122 (S) is laterally surrounded by, or sandwiched between, two ground lines 121, 123 (G), wherein the signal line 122 and the two ground lines 121, 123 are arranged in a same plane thereby being coplanar.

As can be seen in FIG. 9, the two ground lines 121, 123 are electrically coupled to a grounded backside metallization 120, e.g., by means of vias 126, 127 extending vertically through the base film substrate 110. The grounded backside metallization 120 may be arranged on the bottom surface 112 of the film substrate 110 that faces away from the interposers 141, 142. The grounded backside metallization 120 as well as the vias 126, 127 can also be seen in FIG. 1 in context with the other structural parts of the antenna device 100 as discussed herein.

Accordingly, so-called ground traces 121, 123 or areas that are used as ground or reference areas for the signal-carrying conductive traces 122 may be provided. In conductive traces 120, 121, 123 being structured on both sides, the ground areas can be electrically connected to each other by vias 126, 127 extending through the base film substrate 110 such that the so-called coplanar waveguide structures can be realized.

As mentioned above, the flexible base film substrate 110 can comprise a multi-layer foil structure where signal lines 122 and shielding lines 121, 123 are arranged such that the signal lines 122 are mostly surrounded by grounding areas. The areas above and below a signal line 122 can be metal areas arranged at a small and also defined distance via an insulating material. Laterally of the signal lines 122, the shielding can be realized by a series of electrically conductive vias (two of which are shown in FIG. 9 referenced with reference numerals 126 and 127) between the upper and lower metal areas 120, 121, 123. This may provide for a three-dimensional shielding structure for a signal line 122, similar to a conventional coaxial cable. For this, an additional foil that is also metallized on or below the base film substrate 110 (carrying the signal lines 122), can be laminated, which results in an optimized shielding of the signal lines 122. By the defined distance between metallic structures (shielding/grounding/ground/bulk) and the signal-conducting conductors 122, an impedance-controlled wave guide becomes possible which can guide signals up to 100 GHz in a low-loss manner.

Thus, according to some embodiments, the flexible film substrate 110 may comprise a plurality of grounded via structures 126, 127 being electrically coupled to the two ground lines 121, 123 and to the grounded backside metallization 120, wherein the via structures 126, 127 may run in parallel to the signal line 122 (when viewed from top or bottom) thereby providing a three-dimensional RF-shielding structure.

In the following section, the innovative concept shall be summarized in an alternative wording:

The present disclosure describes an innovative scalable conformal (pliable) antenna structure 100, which is herein also referred to as a flexible and modular antenna device 100.

The antenna device 100 may provide a modular integrable structure of one or more single RF-modules 131, 132 (=RF-chip 161, 162 with antenna structures 151, 152 provided on an interposer 141, 142), which are mounted on a flexible base film substrate 110 carrying conductive traces 121, . . . , 125. Each RF-module 131, 132 represents a small-area island on the flexible, thus bendable, base film substrate 110.

So, the innovative antenna device 100 may basically comprise the following different main components: an insulating flexible film substrate 110 carrying conductive trace structures 120, . . . , 125, and at least one RF-module 131 comprising a semiconductor device for signal processing, which is the first RF-chip 161, and an electrically insulating interposer 141 with conductive antenna structures 151. However, the antenna device 100 may comprise a plurality of RF-modules 131, 132, . . . similar or identical to the ones described above.

One of several key advantages of the proposed innovative concept is that each part of the system can be manufactured by methods that are best suited for the functionality of this particular part. For example, the RF-ICs 161, 162 can be produced on wafer level and by appropriate semiconductor process technologies for the specific semiconductor material, e.g., GaN, SiGe or others.

The interposers 141, 142 can be manufactured on glass wafers, again by standard wafer based process technologies. This allows for high accuracy and high performance metal patterns for the antenna structures 151, 152 and any interconnects. Adding a second metal layer onto the glass wafer patterns can easily be achieved as well, for instance, additional routing layers (redistribution layers) on the front side of the glass-wafer (representing the glass interposer 141, 142).

Also, the assembly of the RF-ICs 161, 162 on the glass substrate can be accomplished on wafer level. After cutting the glass wafer into separated glass-elements, the glass interposers 141, 142 comprising RF-ICs 161, 162 and antenna structures 151, 152 are readily available.

The same holds for the manufacture of wiring patterns (i.e., wiring structures 121, . . . , 125) on the flexible base film substrate 110. In this case, several stripe configurations can be produced in parallel on large area film substrates. In some cases the use of roll-to-roll processing will be specifically advantageous.

All in all, this is the base for the modularity of the innovative concept. New applications might require changing RF-IC devices and preparing a new layout for the interconnects. But the basic manufacture processes for the whole system remains.

The flexible and modular antenna device 100 may preferably be configured for radiation and reception of waves 261, 262 in the frequency range of 1 GHz to 300 GHz, and it may be built as compact as possible, very light and such that it may “see” almost simultaneously in many directions; for example, a RADAR system having a 360-degree view, without any movable mechanical components may be realized. Additionally, the innovative antenna device 100 is highly suitable for the integration on non-planar and/or movable surfaces.

The antenna device 100 may comprise several single RF-modules 132, 132 arranged on an elongated strip 110 that may be very light, bendable and flat. Thereby, the flexible antenna device 100 can be used, for example, as a 360-degree RADAR, e.g., for autonomously flying drones. This will become of interest when, for example, several drones head for the same target, for example during transport or rescue tasks. Then, the drones need RADAR detection of other drones in order to prevent collisions.

Accordingly, an important feature of the present invention may be the combination of a semiconductor chip 161, 162 with an RF-suitable interposer 141, 142 and a flexible foil/film substrate 110.

According to an embodiment, the interposers 141, 142 may be made of glass of a non-specified thickness.

According to a further embodiment, the interposers 141, 142 may be made from flexible glass, e.g., with a thickness of 20 μm to 100 μm, or from a flexible composite material.

According to a further embodiment, the antenna device 100 may provide for a 360-degree view.

A further embodiment may concern an active and controlled deformation of the base foil (flexible film substrate) 110 in order to define or change a radiation/receiving direction during operation.

According to a further embodiment, a metallized layer/film/foil 120 may be additionally deposited or laminated onto to flexible film substrate 110 for shielding the signal lines 122 on the base foil (flexible film substrate) 110.

According to a further embodiment, cavities may be provided in the film substrate 110 for allowing an encapsulation and a very short, low-loss connection of the RF-chip 161, 162 to the antenna structures 151, 152.

In the following, some advantageous embodiments shall be described:

According to a first embodiment, it is suggested to provide a flexible and modular antenna device (100), comprising:
a flexible film substrate (110) with electrically conductive wiring structures (121, . . . , 125),
a first RF-module (131) (RF: Radio Frequency) being arranged on the flexible film substrate (110), wherein the first RF-module (131) is coupled to the wiring structures (121, . . . , 125),
wherein the first RF-module (131) comprises:
   a first interposer (141) being suitable for high-frequency use, the first interposer (141) having a first RF antenna structure (151) arranged on a first interposer surface (141A),
   a first RF-chip (161) arranged on the first interposer surface (141A) and configured to provide RF-signals to, or to receive RF-signals from, the first RF antenna structure (151) and to translate the RF-signals into lower frequency baseband signals which are transferred along the wiring structures (121, . . . , 125) of the flexible film substrate (110),
   a plurality of contact pads (171, . . . , 175) arranged on the first interposer surface (141A) for electrically contacting the first RF-chip (161), the contact pads (171, . . . , 175) being electrically coupled directly to the first RF antenna structure (151) via short conductor path structures (180), and
   vias (191, . . . , 194) extending through the first interposer (141) between the first interposer surface (141A) and an opposite second interposer surface (141B),
wherein the first RF-module (131) is mounted with its second interposer surface (141B) on the flexible film substrate (110), such that the vias (191, . . . , 194) connect the contact pads (171, . . . , 175) on the first interposer surface (141A) with the wiring structures (121, . . . , 125) on the flexible film substrate (110).

According to a second embodiment being combinable with the first embodiment, the flexible film substrate (110) and the first interposer (141) may comprise an electrically insulating material.

According to a third embodiment being combinable with the first or second embodiment, the flexible film substrate (110) may comprise, or may consists of, polyimide.

According to a fourth embodiment being combinable with at least one of the first to third embodiments, the flexible film substrate (110) may be configured as an elongated flexible strip.

According to a fifth embodiment being combinable with at least one of the first to fourth embodiments, the flexible film substrate (110) may be curved.

According to a sixth embodiment being combinable with at least one of the first to fifth embodiments, the antenna device (100) may further comprise:
a second RF-module (132) being arranged on the flexible film substrate (110), spaced apart from the first RF-module (131), wherein the second RF-module (132) is coupled to the first RF-module (131) via the wiring structures (121, . . . , 125) of the flexible film substrate (110),
wherein the second RF-module (132) comprises:
   a second interposer (142) being suitable for high-frequency use, the second interposer (142) having a second RF antenna structure (152) arranged on a first interposer surface (142A),
   a second RF-chip (162) arranged on the first interposer surface (142A) and configured to provide RF-signals to, or receive RF-signals from, the second RF antenna structure (152) and to translate the RF-signals into lower frequency baseband signals which are transferred along the wiring structures (121, . . . , 125) of the flexible film substrate (110),
   a plurality of contact pads (271, . . . , 273) arranged on the first interposer surface (142A) for electrically contacting the second RF-chip (162), the contact pads (271, . . . , 273) being electrically coupled directly to the second RF antenna structure (152) via short conductor path structures (181), and
   vias (291, . . . , 293) extending through the second interposer (142) between the first interposer surface (142A) and an opposite second interposer surface (142B),
wherein the second RF-module (132) is mounted with its second interposer surface (142B) on the flexible film substrate (110), such that the vias (291, . . . 293) connect the contact pads (271, . . . , 273) on the first interposer surface (142A) with the wiring structures (121, . . . , 125) on the flexible film substrate (110).

According to a seventh embodiment being combinable with the sixth embodiment, the flexible film substrate (110) may be bent into a curved shape, wherein the first RF-module (131) and the second RF-module (132) are both arranged on an outer circumference (300) of the curved flexible film substrate (110).

According to an eighth embodiment being combinable with the sixth or seventh embodiments, the antenna device (100) may comprise a multi-directional antenna radiation pattern, wherein the first RF-module (131) and the second RF-module (132) are arranged on different positions along an outer circumference (300) of the curved flexible film substrate (110), so as to be oriented towards two different directions and thereby radiating in two different directions (251, 252) for creating the multi-directional radiation pattern.

According to a ninth embodiment being combinable with at least one of the sixth to eighth embodiments, the antenna device (100) may comprise a 360° degree antenna radiation pattern, wherein the first RF-module (131) and the second RF-module (132) are arranged on two opposite positions along an outer circumference (300) of the curved flexible film substrate (110), so as to be oriented towards two opposite directions and thereby radiating in two opposite directions (251, 253) for creating the 360° degree antenna radiation pattern.

According to a tenth embodiment being combinable with at least one of the sixth to ninth embodiments, the antenna device (100) may further comprise a control unit being coupled to the first RF-module (131) and to the second RF-module (132) via the electrically conducting wiring structures (121, . . . , 125) of the flexible film substrate (110), wherein the control unit is configured to output an RF-output signal of the antenna device (100) based on a combination of a first RF-signal received from the first RF-module (131) and a second RF-signal received from the second RF-module (132).

According to a eleventh embodiment being combinable with at least one of the preceding embodiments, the antenna device (100) does not comprise a phased-array antenna.

According to a twelfth embodiment being combinable with at least one of the preceding embodiments, the first RF antenna structure (151) is fixed on the first interposer (141), such that the first RF-module (131) does not comprise any mechanically movable antenna elements.

According to a thirteenth embodiment being combinable with at least one of the preceding embodiments, the first interposer (141) may be suitable for high-frequency use due to its material comprising at least one of glass, quartz or a ceramic composite material.

According to a fourteenth embodiment being combinable with at least one of the preceding embodiments, the first interposer (141) may be laminated onto the flexible film substrate (110).

According to a fifteenth embodiment being combinable with at least one of the preceding embodiments, the first interposer (141) may comprise a thickness of more than 300 μm, which renders the first interposer (141) rigid, or wherein the first interposer (141) comprises a thickness of less than 100 μm, and preferably less than 40 μm, which renders the first interposer (141) flexible.

According to a sixteenth embodiment being combinable with at least one of the preceding embodiments, the first RF-chip (161) may be rigid.

According to a seventeenth embodiment being combinable with at least one of the preceding embodiments, the first RF-chip (161) may be configured as a bare die being flip-chip mounted onto the contact pads (171, . . . , 175) provided on the first interposer surface (141A) of the first interposer (141).

According to an eighteenth embodiment being combinable with at least one of the preceding embodiments, the flexible film substrate (110) may comprise a grounded backside metallization (120) being provided on a film substrate side (112) facing away from the first interposer (141).

According to a nineteenth embodiment being combinable with at least one of the preceding embodiments, the electrically conducting wiring structures (121, . . . , 125) may be provided in a grounded coplanar waveguide configuration, wherein a signal line (122) is laterally surrounded by two ground lines (121, 123), wherein the signal line (122) and the two ground lines (121, 123) are arranged in a same plane thereby being coplanar, and wherein the two ground lines (121, 123) are electrically coupled to the grounded backside metallization (120).

According to a twentieth embodiment being combinable with at least one of the preceding embodiments, the flexible film substrate (110) may comprise a plurality of grounded via structures (126, 127) being electrically coupled to the two ground lines (121, 123) and to the grounded backside metallization (120), wherein the via structures (126, 127) run in parallel to the signal line (122) thereby providing a three-dimensional RF-shielding structure.

According to a twenty-first embodiment being combinable with at least one of the preceding embodiments, the flexible film substrate (110) may be configured as a multi-layer film stack, wherein the electrically conducting wiring structures (121, . . . , 125) are provided as integrated metal layers.

According to a twenty-second embodiment being combinable with at least one of the preceding embodiments, the electrically conducting wiring structures (121, . . . , 125) may be configured as surface striplines provided on a film substrate side (111) facing the first interposer (141).

According to a twenty-third embodiment being combinable with at least one of the preceding embodiments, the first interposer (141) may comprise an RF-reflector (410) facing the first RF antenna structure (151), the RF-reflector (410) being configured to reflect RF-waves (261) emitted by the first RF antenna structure (151) back in the opposite direction, wherein the RF-reflector (410) is provided as a metallization layer being integrated in the first interposer (141), or wherein the RF reflector (410) is provided as a metallization layer being arranged on a second interposer surface (141B) of the first interposer (141) opposite the first interposer surface (141A) of the first interposer (141).

According to a twenty-fourth embodiment being combinable with the twenty-third embodiment, the RF-reflector (410) may be flexible.

According to a twenty-fifth embodiment being combinable with at least one of the preceding embodiments, the first interposer (141) may comprise a cavity inside of which the first RF-chip (161) is mounted.

According to a twenty-sixth embodiment being combinable with the twenty-fifth embodiment, the first RF-chip (161) may be mounted flush inside the cavity such that its upper surface is aligned with an upper surface of the first RF antenna structure (151).

According to a twenty-seventh embodiment being combinable with at least one of the preceding embodiments, the first RF-chip (161) may be designed for transmitting or receiving RF signals having a frequency between 1 GHz and 350 GHz, and preferably between 100 GHz and 350 GHz.

According to a twenty-eighth embodiment, a three-dimensional molded body is proposed, said three-dimensional body having at least one flexible and modular antenna device (100) according to one of the preceding embodiments arranged thereon, wherein the antenna device (100) assumes the shape of the surface contour of the three-dimensional molded body.

According to a twenty-ninth embodiment being combinable with the twenty-eighth embodiment, a radiation characteristic of the antenna device (100) may depend on the shape of the surface of the three-dimensional molded body on which the antenna device (100) is arranged.

According to a thirtieth embodiment being combinable with the twenty-eighth or twenty-ninth embodiment, the antenna device (100) may be arranged on the surface of the three-dimensional molded body such that the first and second RF-modules (131, 132) transmit RF-radiation (261, 262) in a transmission range covering 360° around the molded body, or such that the first and second RF-modules (131, 132) receive RF-radiation (261, 262) in a reception range covering 360° around the molded body.

According to a thirty-first embodiment being combinable with at least one of the twenty-eighth to thirtieth embodiments, the three-dimensional molded body may comprise a spherical shape.

According to a thirty-second embodiment being combinable with at least one of the twenty-eighth to thirty-first embodiments, the three-dimensional molded body may comprise a mechanically changeable surface so that a radiation characteristic of the antenna device (100) can be changed during operation based on a current shape of the surface of the three-dimensional molded body.

According to a thirty-third embodiment being combinable with at least one of the preceding embodiments, the flexible film substrate (100) may be configured to conform its shape to an underlying non-planar surface, wherein the shape of said surface can be invariable or variable.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While this disclosure has been described with reference to illustrative embodiments, this description is not intended to be construed in a limiting sense. Various modifications and combinations of the illustrative embodiments, as well as other embodiments of this disclosure, will be apparent to persons skilled in the art upon reference to the description. It is therefore intended that the appended claims encompass any such modifications or embodiments.

What is claimed is:

1. A flexible and modular antenna device, comprising:
a flexible film substrate with electrically conductive wiring structures,
a first RF-module (RF: Radio Frequency) being arranged on the flexible film substrate, wherein the first RF-module is coupled to the wiring structures,
wherein the first RF-module comprises:
a first interposer being suitable for high-frequency use, the first interposer having a first RF antenna structure arranged on a first interposer surface,
a first RF-chip arranged on the first interposer surface and configured to provide RF-signals to, or to receive RF-signals from, the first RF antenna structure and to translate the RF-signals into lower frequency baseband signals which are transferred along the wiring structures of the flexible film substrate,
a plurality of contact pads arranged on the first interposer surface for electrically contacting the first RF-chip, the contact pads being electrically coupled directly to the first RF antenna structure via short conductor path structures, and
vias extending through the first interposer between the first interposer surface and an opposite second interposer surface,
wherein the first RF-module is mounted with its second interposer surface on the flexible film substrate, such that the vias connect the contact pads on the first interposer surface with the wiring structures on the flexible film substrate.

2. The flexible and modular antenna device according to claim 1,
wherein the flexible film substrate and the first interposer both comprise an electrically insulating material.

3. The flexible and modular antenna device according to claim 1,
wherein the flexible film substrate comprises, or consists of, polyimide.

4. The flexible and modular antenna device according to claim 1,
wherein the flexible film substrate is configured as an elongated flexible strip.

5. The flexible and modular antenna device according to claim 1,
further comprising a second RF-module being arranged on the flexible film substrate, spaced apart from the first RF-module, wherein the second RF-module is coupled to the first RF-module via the wiring structures of the flexible film substrate,
wherein the second RF-module comprises:
a second interposer being suitable for high-frequency use, the second interposer having a second RF antenna structure arranged on a first interposer surface,
a second RF-chip arranged on the first interposer surface and configured to provide RF-signals to, or receive RF-signals from, the second RF antenna structure and to translate the RF-signals into lower frequency baseband signals which are transferred along the wiring structures of the flexible film substrate,
a plurality of contact pads arranged on the first interposer surface for electrically contacting the second RF-chip, the contact pads being electrically coupled directly to the second RF antenna structure via short conductor path structures, and
vias extending through the second interposer between the first interposer surface and an opposite second interposer surface,
wherein the second RF-module is mounted with its second interposer surface on the flexible film substrate, such that the vias connect the contact pads on the first interposer surface with the wiring structures on the flexible film substrate.

6. The flexible and modular antenna device according to claim 5,
wherein the flexible film substrate is bent into a curved shape, and
wherein the first RF-module and the second RF-module are both arranged on an outer circumference of the curved flexible film substrate.

7. The flexible and modular antenna device according to claim 6,
comprising a multi-directional antenna radiation pattern,
wherein the first RF-module and the second RF-module are located at different positions along the outer circumference of the curved flexible film substrate, so as to be oriented towards two different directions and thereby radiating in two different directions, and
wherein the multi-directional radiation pattern is achieved by combining the signals received from the first RF-module radiating in a first direction and from the second RF-module radiating in a different second direction.

8. The flexible and modular antenna device according to claim 5,
further comprising a control unit being coupled to the first RF-module and to the second RF-module via the electrically conducting wiring structures of the flexible film substrate, and
wherein the control unit is configured to generate an RF-output signal of the antenna device based on a combination of a first RF-signal received from the first RF-module and a second RF-signal received from the second RF-module.

9. The flexible and modular antenna device according to claim 6,
further comprising at least a third RF-module,
wherein the antenna device comprises a 360° degree antenna radiation pattern,
wherein the first, second and third RF-modules are located at three different positions along the outer circumference of the curved flexible film substrate, so as to be oriented towards three different directions and thereby radiating in three different directions, and
wherein the 360° degree antenna radiation pattern is achieved by combining the signals received from all three RF-modules radiating in said three different directions.

10. The flexible and modular antenna device according to claim 9,
further comprising a control unit being coupled to the first, second and third RF-modules via the electrically conducting wiring structures of the flexible film substrate, and
wherein the control unit is configured to generate an RF-output signal of the antenna device based on a combination of a first RF-signal received from the first RF-module, a second RF-signal received from the second RF-module, and a third RF-signal received from the third RF-module.

11. The flexible and modular antenna device according to claim 1,
wherein the first RF-chip is configured as a bare die being flip-chip mounted onto the contact pads provided on the first interposer surface of the first interposer.

12. The flexible and modular antenna device according to claim 1,
wherein the first interposer is suitable for high-frequency use due to its material comprising at least one of glass, quartz or a ceramic composite material.

13. The flexible and modular antenna device according to claim 1,
wherein the first interposer comprises a thickness of more than 300 μm, which renders the first interposer rigid, or
wherein the first interposer comprises a thickness of less than 100 μm, and preferably less than 40 μm, which renders the first interposer flexible.

14. The flexible and modular antenna device according to claim 1,
wherein the flexible film substrate is configured to conform its shape to an underlying non-planar surface, wherein the shape of said surface can be invariable or variable.

15. The flexible and modular antenna device according to claim 1,
wherein the flexible film substrate comprises a grounded backside metallization being provided on a film substrate side facing away from the first interposer.

16. The flexible and modular antenna device according to claim 15,
wherein the electrically conducting wiring structures are provided in a grounded coplanar waveguide configuration, wherein a signal line is laterally surrounded by two ground lines, wherein the signal line and the two ground lines are arranged in a same plane thereby being coplanar, and
wherein the two ground lines are electrically coupled to the grounded backside metallization.

17. The flexible and modular antenna device according to claim 16,
wherein the flexible film substrate comprises a plurality of grounded via structures being electrically coupled to the two ground lines and to the grounded backside metallization, and
wherein the via structures run in parallel to the signal line thereby providing a three-dimensional RF-shielding structure.

18. The flexible and modular antenna device according to claim 1,
wherein the electrically conducting wiring structures are configured as surface striplines provided on a film substrate side facing the first interposer.

19. The flexible and modular antenna device according to claim 1,
wherein the flexible film substrate is configured as a multi-layer film stack, wherein the electrically conducting wiring structures are provided as integrated metal layers.

20. The flexible and modular antenna device according to claim 1,
wherein the first interposer comprises an RF-reflector facing the first RF antenna structure, the RF-reflector being configured to reflect RF-waves emitted by the first RF antenna structure back in the opposite direction, and
wherein the RF-reflector is provided as a metallization layer being integrated in the first interposer, or
wherein the RF reflector is provided as a metallization layer being arranged on a second interposer surface of the first interposer opposite the first antenna structure.

21. The flexible and modular antenna device according to claim 20,
wherein the RF-reflector is flexible.

22. The flexible and modular antenna device according to claim 1,
wherein the first interposer comprises a cavity inside of which the first RF-chip is mounted.

23. The flexible and modular antenna device according to claim 1,
wherein the first RF-chip is designed for transmitting or receiving RF signals having a frequency between 1 GHz and 350 GHz, and preferably between 100 GHz and 350 GHz.
